(19) United States
(12) Patent Application Publication
(10) Pub. No.: US 2007/0011491 A1
(43) Pub. Date: Jan. 11, 2007

(54) Method for platform independent management of devices using option ROMs

(76) Inventors: Priya Govindarajan, Hillsboro, OR (US); David Durham, Beaverton, OR (US); Mark Doran, Olympia, WA (US); William Patrick Maynard, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,006

(22) Filed: Jun. 30, 2005

(51) Int. Cl. G06F 11/00

(52) U.S. Cl. 714/27

(57) ABSTRACT

A method for platform independent management of devices using option ROMs. Under one embodiment of the method, manageability data is stored in an option ROM of a peripheral device of a computer platform. The manageability data includes a descriptor that provides an identity, data type, access method and potentially other data to discover, access, and control the device. An embedded instance of the Sensor/Effector Interface (SEI) subsystem is provided by a management engine (ME) implementation via execution of corresponding firmware by the ME. Via the use of an out-of-band communication channel facilitated by the ME or other means (e.g., LAN microcontroller), management data retrieved from option ROMs, and the SEI, a remote management server is enabled to remotely manage various devices and/or the computer platform.

### FIELD OF THE INVENTION

The field of invention relates generally to computer systems and, more specifically but not exclusively relates to platform-independent techniques for performing management of computer system devices.

### BACKGROUND INFORMATION

Recent research studies concerning the use of information technology (IT) reveals about 50 percent of IT spending is on people, including internal IT payroll and external professional services. Additionally, more than 80 percent of IT spending is for the people and technology required to keep the business running, rather than for business transformation through new development and enhancements (e.g., new hardware and software). With the increasing frequency of network-wide hacking, security concerns, and virus attacks, there is more need than ever before to efficiently manage IT hardware resources. Furthermore, to enhance security and reliability, compliance requirements have been recently codified into law, such as Sarbanes-Oxley in the United States and similar regulations in the European Union (EU) and Asia. The addition of these requirements will add significant pressure on IT staff and IT budgets.

Currently, most IT platform management for enterprises (e.g., mid to large businesses) is facilitated using “in-band” tools that support remote platform management. A typical in-band tool comprises an agent that is hosted by an operating system running on a given platform. A central management server or the like is used by IT personnel to interact with the agents running on various platforms within an enterprise to perform remote management operations such as installing software updates, detecting virus attacks, etc. This approach is cumbersome and may not be available under many circumstances. For example, an appropriate agent must be installed and running on each platform being managed. If the agent is removed, the platform is turned off, or the operating system is not in the proper state (e.g., crashed or hung), the agent cannot be accessed, and thus remote platform management cannot be performed. The use of such in-band agents also may cause objectionable slow downs that are noticeable to users.

In addition to in-band management solutions, techniques for employing platform management via out-of-band (OOB) have been introduced. Such solutions enable platform management to be performed without OS complicity, providing platform-independent support. To facilitate both in-band and OOB management approaches, various management interfaces and standards have been developed, including the Intelligent Platform Management Interface (IPMI), the Alert Standard Format (ASF), the Pre-boot execution Environment (PXE) and the Stable Image Platform Program (SIPP). In some implementations, a platform may include a separate management processor that is employed to perform the management operations.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 illustrates the format of an option ROM header;

FIG. 2 illustrates a manageability data structure, according to one embodiment of the invention;

FIG. 3 is block schematic diagram illustrating datapaths between a device, a management engine, and a host operating system;

FIG. 4 is a flowchart illustrating operations and logic performed during retrieval and authentication of manageability data store in the option ROMs of various devices on a managed platform;

FIG. 5 is a schematic diagram illustrating retrieval of management data from a secure vendor site using a URI contained in a managed device's option ROM;

FIG. 6 is a schematic diagram illustrating the various interfaces and components of a Sensor/Effector Interface (SEI) subsystem;

FIG. 7 is a schematic diagram of a platform architecture corresponding to a managed host that includes provisions to support remote management operations via manageability data and an instance of the SEI subsystem; and

FIG. 8 is a schematic block diagram illustrating components of a LAN microcontroller and management engine used in the platform architecture of FIGS. 3 and 7, according to one embodiment of the invention.

### DETAILED DESCRIPTION

Embodiments of methods and apparatus for performing platform-independent management of devices using option ROMs are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Management of the different devices on a platform is one of the difficult challenges faced by IT administrators. One of the aspects of an autonomic self-healing and self-optimizing platform is the ability to inspect the capabilities available on different devices and use that information intelligently to reduce the burden on the user and administrator. There are a number of innovative capabilities that can be provided on the platform when there is a way to discover the devices on the platform, discover the capabilities offered by these devices, and manage them. In the Intel® Active Management Technology (Intel AMT) architecture, a service or management engine/processor (ME), or other firmware partition resides on the platform and autonomics and management capabilities are run on this ME. Information about the different devices on the platform is exposed via a common, secure and extensible interface—the Sensor Effector Interface (SEI). By defining a common platform interface, the SEI allows the downloadable Capability Modules (CMs) (scripts and programs) running on the ME to access a single interface for managing many different devices and instruments on the host platform. As part of the SEI, Resource Data Records (RDRs) are used to accurately discover, identify, and describe all manageable platform resources.

In accordance with aspects of the embodiments described herein, option ROMs are employed as a means for providing the device-specific code for managing the device and/or a description of the manageable features expressed in the form of Resource Data Records for that device in a platform-independent manner. This provides a convenient mechanism to facilitate platform-independent management of devices having associated option ROMs and platforms that employ such devices without having to define any new standards or interfaces. Rather, extensions to existing standards are implemented for these purposes.

An option ROM (also referred to as an expansion ROM) is a firmware component associated with a specific add-on peripheral device. Traditionally, the option ROMs of such devices allow an IHV (Independent Hardware Vendor) to supply additional firmware to boot and configure its peripheral device and to extend the functionality of the system firmware (BIOS) during the boot process. In general, the associated device may reside on the system-board or on a Plug and Play card or the like (e.g., a PCI add-on card). Accordingly, a device's option ROM will reside in system ROM or on-board the peripheral device or device host. Option ROMs are intended to isolate a hardware device by providing an abstract interface that implements device-specific functions, including power-on self-test (POST), initialization, interrupt service routines and BIOS routines.

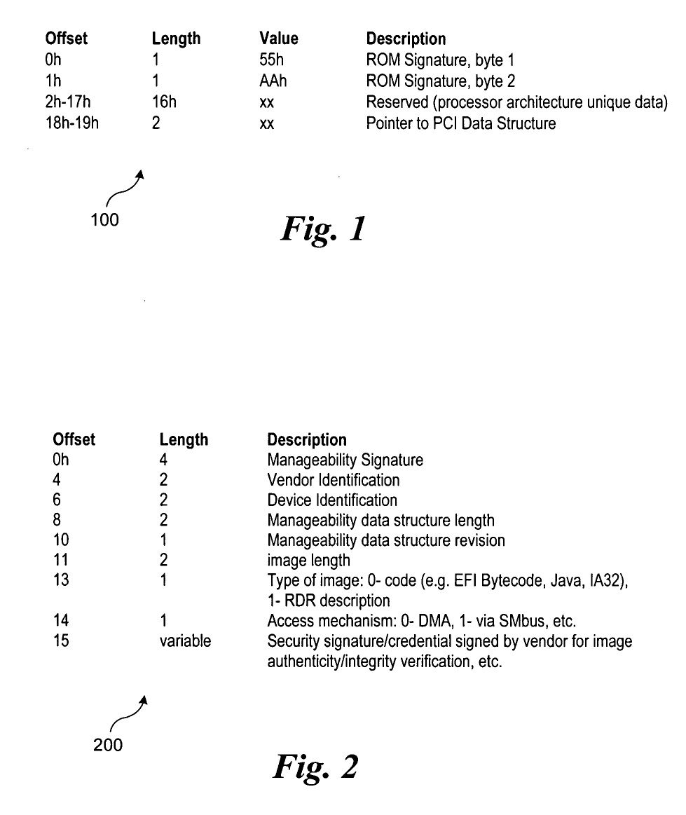

When a device supports an expansion ROM or option ROM, the size of the ROM is indicated via the base address registers in the configuration space. The BIOS typically uses this information to access the ROM and shadows the data in RAM during the pre-boot. There may be many images in the ROM, but each image must start on a 512-byte boundary and must contain the option ROM header, which specifies to the BIOS the location of the initialization vector and also contains an expansion header. Typically, the ROM header has a two-byte signature field containing a 55 h in the first byte and AAh in the second byte, as illustrated by an option ROM header 100 in FIG. 1. This signature must be the first two bytes of the ROM address space for each image of the ROM. If this signature is not present, the ROM image is ignored by the BIOS.

Under one embodiment, the PCI data structure is used to store the management information to be employed for associated platform management operations. The location of the PCI data structure is identified by the Pointer to PCI Data Structure field of option ROM header 100. In general, there are two types of information that can be stored in the Option ROM: code for managing the device and/or RDR information specific to the device. In one embodiment, a manageability data structure including a header followed by manageability data is employed. As illustrated by a header 200 for a manageability data structure shown in FIG. 2, the header provides information specific to the data being presented, such as the device identifier (ID), vendor ID, length of the image, type of image (code to load or RDR description), mechanism to access the device (via PCI, SMbus (system management bus) or other), security authentication information and indication of more images. As discussed above, it is possible to have multiple option ROM images and the last indicator will help to determine when to stop looking for more images. Furthermore, an option ROM may contain multiple manageability data structures, and the vendor can provide both programmatic code and RDRs by linking the manageability data structures in an appropriate manner.

The option ROM may be used to provide access to device registers that have been memory-mapped and describe the type and information about the registers using the RDRs in the option ROM. In this case, the ME can obtain the starting address for the device from the configuration space of the device and can use the DMA (Direct Memory Access) mechanism to get at the registers. Since the vendor will not know the memory mapping for the device beforehand, the RDR description of the sensors and effectors will be provided as offsets from the Base address of the memory-mapped device registers. RDRs provide the data types, lengths, standard names, descriptions and mapping information (to convert from one data format to another) of the data structures described by the RDRs.

RDRs may also provide the sensor data, command codes and/or control identifiers for access via a serial management bus protocol such as System Management Bus (SMBus) or other I2C physical interface and programmed I/O protocol. In this case, similar to accessing memory mapped device registers, the RDR can describe access to device information via SMBus commands. The access mechanism (SEI provider) is indicated to be via the SMBus and RDRs describe the commands to access and the information returned by the device.

In the case of a device having a management bus distinct from the PCI bus, the ME can access the option ROM using the PCI bus and determine the access mechanism. The device can thus be managed via the management bus (e.g., SMbus), which is connected to the Service processor. As discussed above, the option ROM need only specify the RDRs if the device can be accessed by generic providers preloaded into the ME. However, the device might require a vendor-specific mechanism for accessing and managing it. In this instance, the option ROM may contain program code that can be used for directly managing the device via the specified bus. The vendor is thus not constrained to provide access to the device only via existing or established means. As long as the code exposes an API that meets the requirements imposed by the SEI core (such as the mailbox protocol API) and the appropriate bus access is available on the ME for the vendor code, the vendor can use any proprietary mechanism/protocol to access and manage the device. This may also include communicating with the host device driver if the vendor so desires.

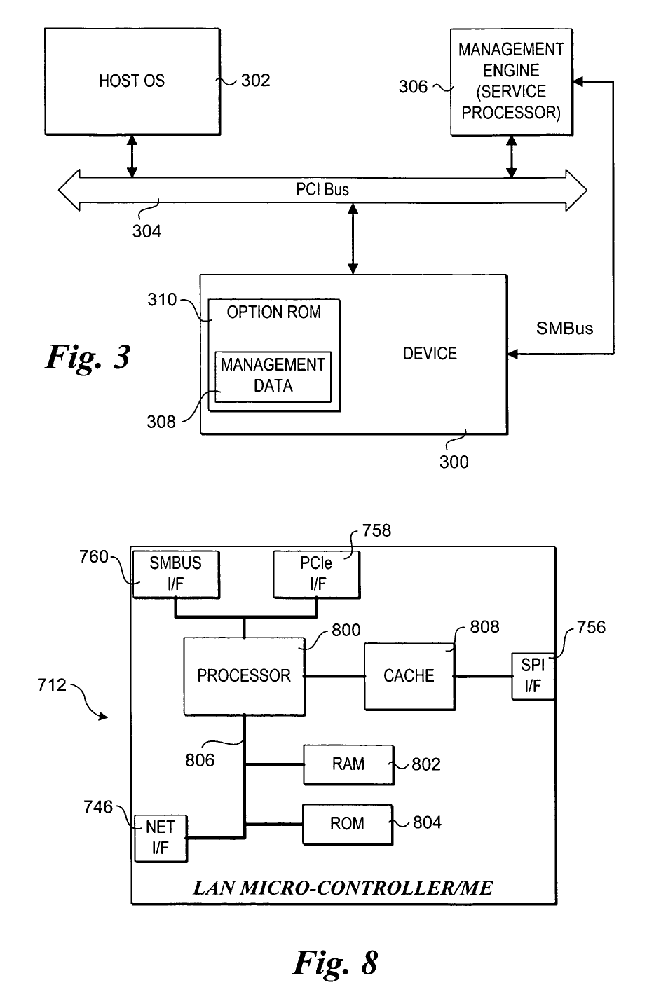

FIG. 3 shows such a configuration where a device 300 is exposed to a host OS 302 via the PCI bus 304, while the management (handled by a management engine 306) of the device is via the SMbus. During device initialization, management data 308 in option ROM 310 is provided to management engine 306 via PCI bus 304. Other device initialization operations may be performed by host OS 302 in a normal manner (e.g., enumeration of PCI devices, device load and initialization, etc.) via communication between the device and the host OS over the PCI bus.

In all of the above scenarios, it is very important to authenticate the source of the management data and also verify the integrity of the information/code contained in the manageability data structure and option ROM image(s). In one embodiment, a hash of the code/data is provided as one of the fields of the header. After the ME has identified the type of information stored in the option ROM, the provisioning module of the ME will validate the security credentials and only if it passes the security check will the data be loaded into the ME.

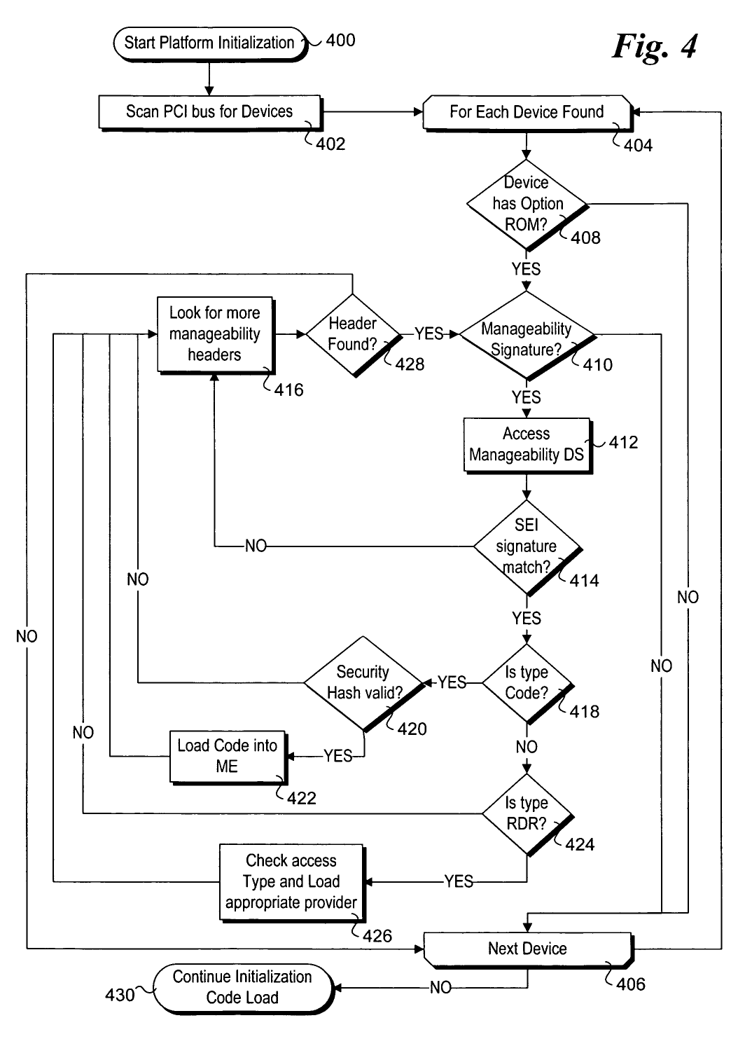

With reference to the flowchart of FIG. 4, management operations facilitated by option ROM manageability data proceed as follows. The process begins in a start block 400, wherein platform initialization is started. In connection with standard initiation practices, the PCI bus is scanned in a block 402 to enumerate the PCI devices for the platform. As depicted by start and end loop blocks 404 and 406, the operations defined between these blocks are performed to evaluate each device that was found during the scan.

First, in a decision block 408 a determination is made to whether the device has an option ROM. If not, the process loops back to evaluate the next device. For each device that has an option ROM, the answer to decision block 408 will be YES, causing the following operations and logic to be performed. In a decision block 410 a determination is made to whether a valid manageability signature is present in the option ROM image. If the signature is not present or otherwise invalid, further operations pertaining to that option ROM are ceased, and the logic loops back to begin evaluation of a next device. If the signature is valid, the logic proceeds to a block 412 in which the manageability data structure is accessed. As discussed above with reference to FIG. 3, under one embodiment the manageability data may be accessed over the PCI bus.

Continuing at a decision block 414, a determination is made to whether the manageability data includes an SEI signature match. If the answer is NO, the logic proceeds to a block 416 to look for more manageability headers. If the answer is YES, the logic proceeds to a decision block 418 to determine whether the manageability data includes type code. If it does, the security hash is checked to verify that the code is valid (e.g., a hash result on code that has been tampered with will not match the hash value, or signed hash value which can be validated with credentials/public keys as coming from/programmed by the correct device vendor, in the header) in accordance with a decision block 420. If the code is valid, it is loaded into the ME in a block 422, and the logic proceeds to block 416 to look for more manageability headers. If the answer to decision block 420 is NO, the logic proceeds directly to block 416 without loading the code load into the ME.

Returning to decision block 418, if the manageability data does not contain code, a determination is made in a decision block 424 to whether the manageability data includes one or more RDRs. If this case is true (YES result), an access type check is performed and the appropriate SEI provider is loaded in a block 426. The logic is then returned to block 416.

As depicted by a decision block 428, a determination is made pertaining to block 416 to whether another manageability data structure header is found. If so (indicating another manageability data structure is present in the option ROM), the logic proceeds to verify the signature in decision block 410, and the aforementioned operations and logic are repeated to evaluate and process this manageability data structure. If there are no more manageability data structures present, the answer to decision block 428 is NO, and the logic returns to start loop block 404 to begin evaluation of a next device. Once all of the devices are evaluated, the logic proceeds to a continuation block 430 to continue the platform initialization code load.

The option ROM and/or manageability data structure may also include a URI (Uniform Resource Identifier) to a network location where the specific RDR information or management related code is available. This provides a secure mechanism for authenticating the source and obtaining the information.

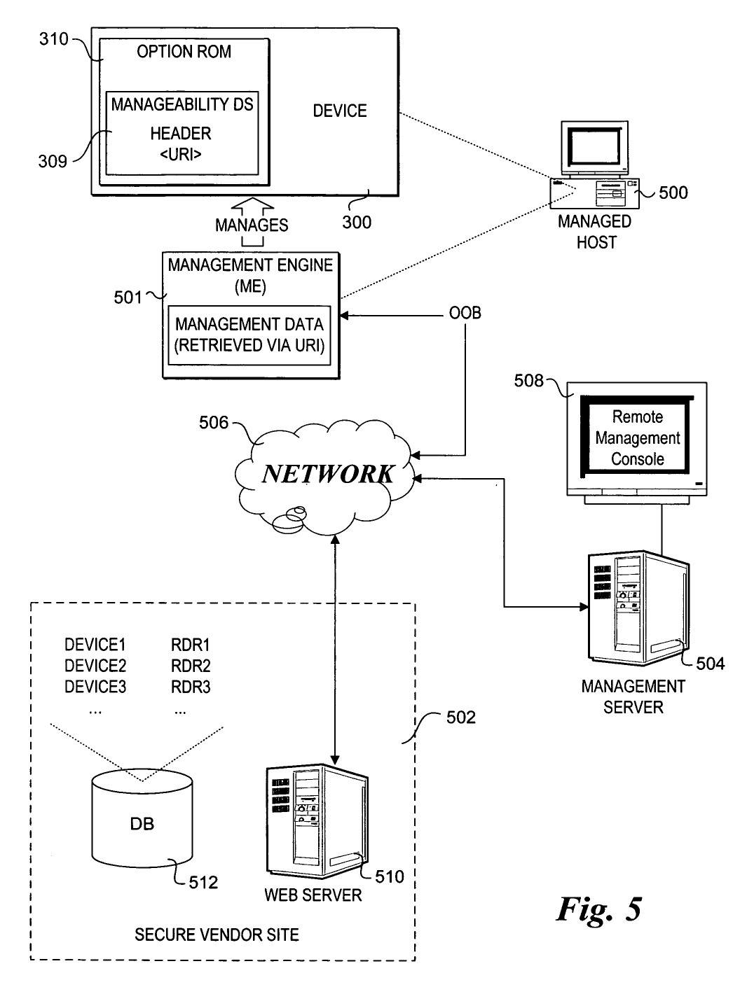

For example, such an implementation is illustrated in FIG. 5. In this case, a device 300 in a managed host 500 includes a manageability data structure 309 in its option ROM 310 that contains a URI that identifies a secure vendor site 502 operated by a vendor of device 300. In one embodiment, the URI information will be stored in an ME 501 of managed host 500 during platform initialization and the ME will employ the URI to submit a request to a web server 510 that provides an access point to secure vendor site 502 for appropriate management data corresponding to device 300 using an OOB channel over a network 506. In response, web server 510 queries a database 512 for the applicable management data (e.g., RDR(s), code, etc.), and returns it to ME 501. Under another approach, in response to a management initiation request by a management server 504, a firmware agent or the like on managed host 500 or ME 501 examines option ROM 310, and retrieves the URI to initiate the foregoing data management retrieval process. The management data may then be employed by the ME to enable device 300 to be remotely managed via remote management console application 508 and/or perform management-related operations on its own.

In one embodiment, the URI comprises a URL (uniform resource locator) that specifies the full path to the network location for the management data for the device. In another embodiment, the ME submits a request that includes a URL to access the secure vendor site along with device identification data. In view of the device identification data, web server 510 generates an appropriate query to retrieve the management data corresponding to device 300 and returns the management data to ME 501. Under some circumstances, the management data may be particular ME implementation, as well as the specific device to be managed. Accordingly, the device identification data would further identify an ME type.

As an option, one or more authentication operations may also be incorporated into this process, such that management server 504 can verify that the management data it retrieves is authentic and hasn't been tampered with. In one embodiment, this can be achieved using vendor credentials also supplied in the option ROM. This public key information can be used to validate that the code or RDRs retrieved from an external source have been signed by the vendor's private key, and are, thus, authentic.

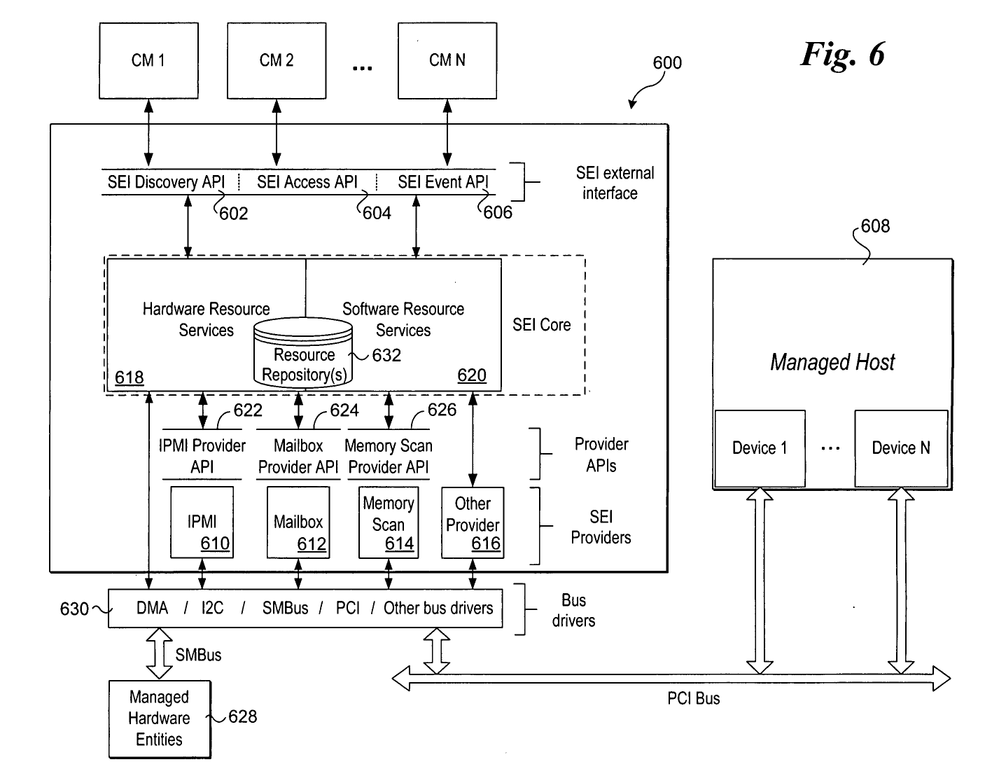

FIG. 6 shows details of the SEI subsystem 600 (also referred to as the Sensor/Effector and Provider subsystem) including the providers and common programmatic interfaces which sandwich them. The SEI subsystem provides a modular and extensible mechanism for managing platform hardware and software. Specifically, the SEI external interface, which includes the SEI Discovery API (application program interface) 602, the SEI Access API 604, and the SEI Event API 606, provides a common mechanism for interacting with managed hardware and software components on the host platform (managed host 608). The Provider portion of SEI subsystem 600 incorporates various drivers (providers) for interacting with the platform hardware to support access to and manipulation of management-related information. These providers are depicted as an IPMI provider 610, a mailbox provider 612, a memory scan provider 614, and other providers 616, which are not specifically identified. Each of these providers is permitted access to hardware resource services 618 and software resource services 620 via a respective API, including an IPMI provider API 622, a mailbox provider API 624, and a memory scan provider API 626. Meanwhile, each of the SEI providers is enabled to access managed hardware entities 628 and managed host devices 1-N via appropriate bus drivers 630, which may include but are not limited to a DMA (direct memory access) driver, an 12C bus driver, an SMBus driver, and a PCI bus driver.

The SEI provides a common abstraction of manageable platform features. By defining a common platform interface, SEI allows embedded capabilities to access a single interface for managing the host platform. Through this interface, embedded capabilities can discover and identify all manageable platform devices and firmware components, read their sensor data, configure their effectors, and handle events generated by the managed entities. The SEI also accommodates controlled access to manageable platform features, determining which capabilities can access which manageable platform features, and ensuring safe access to those features when permitted. The SEI aggregates data provided by the SEI providers that interact with the host platform, implementing code that can safely access the platform's manageable features and translating the managed data into a form that is consistent with the common SEI abstraction. The SEI also provides a framework such that modular and device independent code can be interpreted and run within this framework. This interpreted code, which may be loaded from option ROMs, may interact with the well-defined SEI interfaces, and, thus, perform its logic functions while interacting with the rest of the SEI subsystem and the components running therein.

Additionally, the SEI defines intra-platform message formats, namespaces and record formats that can fully describe and address the manageable components of a platform. Where legacy technologies exist that have different message formats and namespaces, the SEI provider subsystem can be used to map those protocols into the common SEI abstraction. The SEI facilitates secure access to manageable entities by supporting access-control mechanisms, including controlling access requests down to the managed-resource method level. For example, a command write to a particular effector instance could be allowed, but a change to the effector's default start-up value from the same source could be denied.

Under the SEI definitions, a managed resource is any managed entity, individual sensor/effector, or other components that is described by a Resource Data Record (RDR). An entity is a device or other logical grouping of sensors and effectors that contains a description of the device or logical entity and its fully qualified path. A sensor is a read-only resource that produces an output. An effector is a controller resource that takes one or more commands, institutes a change to the managed system and produces an output. An RDR is a descriptor for a particular instance of a managed resource that provides its identity, data type, description, data format conversions, access method and other attributes needed to discover, access, and control the managed resource.

The various SEI interfaces are run-time linkable and can bind a provider to the SEI core (via the Provider APIs) and the appropriate bus driver (via the bus driver interfaces) for accessing the device. The SEI core is responsible for storing all the RDRs collected by the providers during discovery in a resource repository 632. The SEI core uses these RDRs to associate requests from CMs to a particular sensor or control that is accessed through the associated provider. Since these programmatic interfaces are all run-time linkable, a provider can be installed at any time, bond to its selected bus driver and to the SEI core, communicate with its associated device(s) via the bus drivers, and finally the installed provider can populate the SEI core with the appropriate RDRs for its device(s). At this point, downloadable CMs (depicted as CMs 1-N) may access the sensors and controls for that device, gather device inventory information, register for and receive events from the device, and identify the device, its version and type information.

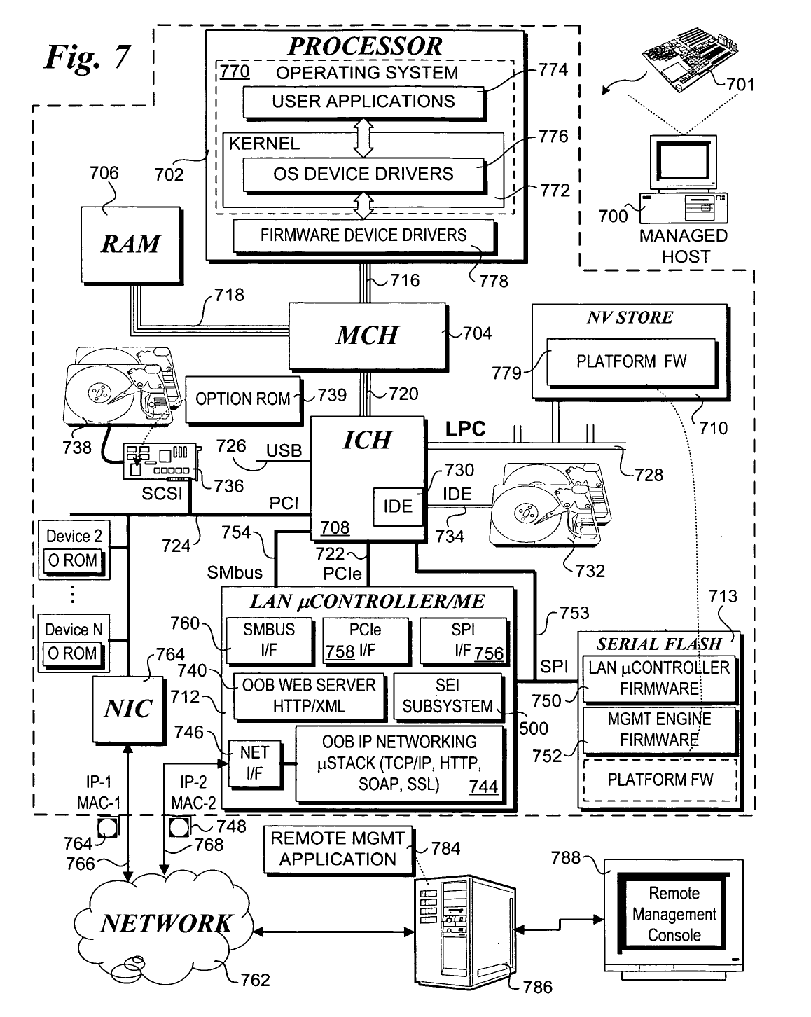

FIG. 7 shows a system architecture 700 that may be used to implement client-side aspects of the remote management techniques discussed herein. The architecture includes various integrated circuit components mounted on motherboard or main system board 701. The illustrated components include a processor 702, a memory controller hub (MCH) 704, random access memory (RAM) 706, an input/output (I/O) controller hub (ICH) 708, a non-volatile (NV) store 710, a local area network (LAN) microcontroller (μC)/ME 712, a serial flash chip 713, and a network interface controller 714. Processor 702 is coupled to MCH 704 via a bus 716, while MCH 704 is coupled to RAM 706 via a memory bus 718 and to ICH 708 via an I/O bus 720.

In the illustrated embodiment, ICH 708 is coupled to LAN microcontroller/ME 712 via a peripheral component interconnect (PCI) Express (PCIe) serial interconnect 722 and to NIC 714 via a PCI bus 724. The ICH may also be connected to various I/O devices via corresponding interfaces and/or ports. These include a universal serial bus (USB) port 726, and a low pin count (LPC) bus 728. In one embodiment, NV store 710 is connected to ICH710 via LPC bus 728. In another embodiment (not shown), the elements of ICH 708 and LAN LAN microcontroller/ME 712 are implemented in a single component.

In the illustrated embodiment, ICH 708 further includes an embedded integrated drive electronics (IDE) controller 730, which, in turn, is used to control one or more ATA IDE (or Enhanced IDE-EIDE) disk drives 732 that are connected to the controller via an IDE interface 734. IDE controllers and IDE disk drives are the most common type of disk drive and controller found in modern PCs and laptop computers. Generally, in addition to the configuration shown, a separate (from ICH 708) IDE controller may be provided for controlling an IDE disk drive.

In some embodiments, a SCSI controller is used in place of or in addition to IDE controller 730. In general, the SCSI controller may be a build-in controller or coupled to an expansion bus as an add-on peripheral card, such as a SCSI controller PCI card 736 coupled to PCI bus 724. The SCSI controller is used to drive one or more SCSI disk drives 738. In general, SCSI disk drive 738 is illustrative of various types of SCSI drives, including but not limited to SCSI-1, SCSI-2, SCSI-3 and ultra-SCSI drives. In addition, SCSI controller PCI card 736 operates as a first managed device, and includes an option ROM 739

LAN microcontroller/ME 712 is configured to perform various operations that are facilitated via corresponding functional blocks. These include an out-of-band (OOB) Web Server 740, an SEI subsystem 500, and an OOB Internet Protocol (IP) networking microstack 744. The OOB Web server 740 and OOB IP networking microstack 740 supports IP networking operations that enable external devices to communicate with LAN micro-controller/ME 712 via a conventional Ethernet connection using Web services facilitated via XML (Extended markup language) sent via HTTP (Hypertext transport protocol). Accordingly, LAN micro-controller/ME 712 also provides a LAN μC network interface 744 that is connected to a platform Ethernet port 746.

To effectuate the operation of its various functional blocks, LAN microcontroller/ME 712 loads LAN microcontroller firmware 750 and management engine firmware 752 from serial flash chip 713 and executes the firmware instructions on its built-in processor. (Details of the LAN microcontroller/ME hardware architecture are shown in FIG. 8 and discussed below.) In one embodiment, the transfer of data from serial flash chip 713 to LAN microcontroller/ME 712 is sent over a Serial Peripheral Interface (SPI) 753. In one embodiment, LAN microcontroller/ME 712 is also coupled to ICH 710 via SPI 753 in addition to PCIe interconnect 722. Furthermore, in one embodiment LAN microcontroller/ME 712 is coupled to ICH 710 via an SMbus 754. Communications via SPI 753 are facilitated by an SPI interface (I/F) 756, while communications via PCIe interconnect 722 are facilitated by a PCIe interface 758, and communications via SMbus 754 are facilitated by an SMbus interface 760.

Under conventional usages, the managed client is enabled to connect to a computer network 762 via a platform NIC Ethernet port 764, which is internally connected to NIC 714. To facilitate concurrent and separate usage, each of platform NIC Ethernet port 764 and LAN pC Ethernet port 748 have respective media access control (MAC) addresses and respective IP addresses. For simplicity, the respective MAC addresses are depicted as MAC-1 and MAC-2, while the respective IP addresses are depicted as IP-1 and IP-2. In general, NIC Ethernet port 764 and LAN μC Ethernet port 748 support respective network links 766 and 768 to network 762 using conventional LAN operations and protocols.

Processor 702 is shown running an operating system 770 including an OS kernel 772. The operating system hosts various user applications 774 running in the OS's user space. The OS kernel includes various OS device drivers 776. The OS device drivers are used to support communication with corresponding hardware devices and peripherals, such as IDE drives 732 and SCSI drives 736. Typically, corresponding firmware device drivers 778 comprising a portion of platform firmware 779 are employed in a firmware layer to support “low-level” device functions, while providing abstracted interfaces to corresponding OS device drivers.

The conventional approach to device management discussed above operatives in the following manner. A user application 774 comprising a remote management agent is loaded into operating system 770, and the user selects to perform one or more platform management operations via a remote console that is linked in communication with the managed host via network 762 and in-band networking facilities. The management agent then performs various management operations, as instructed, using the conventional operating system device drivers 776 and firmware device drivers 778. The results of the management operations (e.g., acquisition of platform configuration for inventory management, diagnosis of platform errors, etc.) are then returned by the user application, to the remote management console.

Notably, the foregoing platform management operations are not available if the platform is not booted and the operating system is running. This greatly limits remote management capabilities, particularly in the event of platform errors and faults. In contrast, under embodiments of the invention, platform management is performed using an OOB channel that does not require any OS complicity. In fact, the primary platform components (e.g., CPU) do not even need to be operating.

In one embodiment, remote platform management operations are initiated by a remote management application 784 running on a remote management server 786 that is connected to network 762. The remote management application issues various management requests and commands to managed host 700 using an out-of-band communication channel facilitated by LAN microcontroller/ME 712. The terminology “out-of-band” refers to a condition where the operating system running on managed host 700 is unaware of the existence of the OOB communication channel or any of its functions. Moreover, OOB communications between managed host 700 and remote management server 786 may occur concurrently with in-band network communications that are sent to various computers and servers coupled to network 762 via network link 766. Such in-band communications are managed and controlled by operating system 774.

Upon receipt of a SOAP/XML message via the OOB communication channel, the message is processed by OOB IP networking microstack 744 to extract the management request or command. The request or command is then processed by the ME aspects of LAN microcontroller/ME 712 using SEI subsystem 600 in the manner described above. In particular, the various add-on peripheral devices and cards are identified, and corresponding option ROM images are evaluated to determine if any contain manageability data structures. If so, the manageability data from those data structures is retrieved and employed by LAN microcontroller/ME 712 to manage the corresponding device via SEI subsystem 600. In view of communication passed between remote management server 786 and LAN microcontroller/ME 712 and management operations performed by the ME on the device via the SEI subsystem, the results of various platform management operations will be displayed on a remote management console 788.

FIG. 8 shows details of a hardware architecture corresponding to one embodiment of LAN microcontroller/ME 712. The LAN microcontroller/ME includes a processor 800, coupled to random access memory (RAM) 802, and read-only memory (ROM) 804 via a bus 806. The LAN microcontroller/ME further includes multiple I/O interfaces, including network interface 746, SPI interface 756, PCIe interface 758 and SMbus interface 760. In one embodiment, a cache 808 is coupled between processor 808 and SPI interface 756.

In general, the operations of the various components comprising OOB IP networking μstack 744, OOB web server 740, and SEI subsystem 600 may be facilitated via execution of instructions provided by LAN microcontroller firmware 750, management engine firmware 752 (or other firmware store on-board LAN microcontroller/ME 712 in ROM 804) on processor 800. Additionally, the operations of SPI interface 756, PCIe interface 758 and SMbus interface 760 may be facilitated via hardware logic and/or execution of instructions provided by LAN microcontroller firmware 750 (or other firmware store on-board LAN microcontroller 712) on processor 800. Furthermore, all or a portion of the firmware instructions may be loaded via a network store using the OOB communications channel. Additionally, remote management application 784 may generally be embodied as sets of instructions corresponding to one or more software modules or applications.

The foregoing ME implementation using an embedded processor is merely exemplary, as ME functionality may be implemented via one of several means. For example, the ME functionality may also be implemented using a management application on the host, a sequestered processor core (dedicated to management) in a multi-core processor, a virtual partition dedicated to management, or a virtual partition associated with a virtual machine monitor (VMM) that performs certain management functions. These various management environments may implement one or more different types of code. For example, such code might include conventional machine code, EFI-(Extensible Firmware Interface) byte code, or a virtual machine code such as Java byte code or the like.

Thus, embodiments of this invention may be used as or to support software and/or firmware instructions executed upon some form of processing core (such as the processor of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
retrieving manageability data from an option ROM (read-only memory) of a device in a computer platform; and
employing the manageability data to support remote management of at least one of the device and the computer platform.

2. The method of claim 1, wherein the manageability data includes information that provides at least one of an identity, data type, data format conversions, descriptions, and access method to discover, access, and control the device.

3. The method of claim 1, further comprising:
authenticating the manageability data.

4. The method of claim 1, further comprising:
employing an instance of a Sensor/Effector Interface (SEI) subsystem to remotely manage the device using the manageability data.

5. The method of claim 1, further comprising:
remotely managing the device while an operating system to run on the computer platform is inoperative.

6. The method of claim 1, further comprising:
remotely managing the device while a main processor for the computer platform is inoperative.

7. The method of claim 1, further comprising:
remotely managing the device using an out-of-band (OOB) communication channel.

8. The method of claim 1, further comprising:
retrieving respective instances of manageability data from respective option ROMs for multiple devices in the computer platform; and
employing the respective instances of the manageability data to remotely manage the multiple devices.

9. The method of claim 1, further comprising:
locating a first manageability data structure in the option ROM;
retrieving a first set of manageability data pertaining to the device from the first manageability data structure;
locating a second manageability data structure in the option ROM;
retrieving a second set of manageability data pertaining to the device from the second manageability data structure; and
employing the first and second sets of manageability data to remotely manage the device.

10. The method of claim 1, further comprising:
scanning a PCI (peripheral component interconnect) bus for devices in the computer platform;
for each device that is found,
determining if it has an option ROM; and if so,
determining if it includes a manageability data structure; and if so,
retrieving manageability data from the manageability data structure; otherwise,
proceeding to evaluate a next device.

11. The method of claim 1, further comprising:
locating a manageability data structure in an option ROM, the manageability data structure including a uniform resource identifier (URI) corresponding to a network location where the manageability data for the device is stored; and
retrieving the manageability data from the network location via the OOB communication channel.

12. The method of claim 11, further comprising:
validating the retrieved manageability data as authentic by validating it with public key/certificate information described in the manageability structure within the option ROM.

13. The method of claim 1, wherein management operations are performed using a management engine implemented as one of an embedded processor, a management application running on the computer platform, a sequestered processor core in a multi-core processor, a virtual partition, or a virtual partition associated with a virtual machine monitor (VMM).

14. A machine-readable medium to provide instructions that if executed on a host computer platform perform operations comprising:
retrieving manageability data from an option ROM (read-only memory) of a device in the host computer platform; and
performing management operations on at least one of the device and the host computer platform, the management operations facilitated, in part, via the manageability data.

15. The machine-readable medium of claim 14, wherein a portion of the instructions comprise a module to effectuate an instance of a Sensor/Effector Interface (SEI) subsystem that provides interfaces via which the device is managed using the manageability data.

16. The machine-readable medium of claim 15, wherein the manageability data includes at least one Resource Data Record that provides at least one of an identity, data type, data format conversions, descriptions, and access method to discover, access, and control the device.

17. The machine-readable medium of claim 14, wherein execution of the instructions performs further operations comprising:
retrieving respective instances of manageability data from respective option ROMs for multiple devices in the computer platform; and
performing management operations on the multiple devices, the management operations for each device facilitated, in part, via the instance of manageability data associated with that device.

18. The machine-readable medium of claim 14, wherein execution of the instructions performs further operations comprising:
locating a first manageability data structure in the option ROM;
retrieving a first set of manageability data pertaining to the device from the first manageability data structure;
locating a second manageability data structure in the option ROM;
retrieving a second set of manageability data pertaining to the device from the second manageability data structure; and
sending the first and second set of manageability data to a remote management server.

19. The machine-readable medium of claim 14, wherein execution of the instructions performs further operations comprising:
scanning a PCI (peripheral component interconnect) bus for devices in the host computer platform;
for each device that is found,
determining if it has an option ROM; and if so,
determining if it includes a manageability data structure; and if so,
retrieving manageability data from the manageability data structure; otherwise,
proceeding to evaluate a next device; and
employing any manageability data that is retrieved to manage a corresponding device.

20. The machine-readable medium of claim 14, wherein execution of the instructions performs further operations comprising:
sending data pertaining to management of the device to a remote management server using an out-of-band communication channel.

21. A computer system, comprising:
a platform processor;
an input/output controller hub (ICH), operatively coupled to the platform processor;
a peripheral device including an option ROM (read-only memory);
an local area network (LAN) microcontroller, operatively coupled to or included in the ICH, the LAN microcontroller including an embedded processor and a network interface to support an out-of-band (OOB) communication channel; and
a storage device, operatively-coupled to the LAN microcontroller and having instructions stored therein, which if executed by the embedded processor perform operations comprising:
retrieving manageability data from the option ROM; and
performing management operations on the peripheral device, the management operations facilitated, in part, via the manageability data.

22. The computer system of claim 21, further comprising:
an executable module comprising a set of instructions stored in the storage device that are to be executed on the embedded processor to facilitate an instance of a Sensor/Effector Interface (SEI) subsystem that provides interfaces via which the device is managed using the manageability data.

23. The computer system of claim 22, wherein execution of the plurality of instructions performs further operations including:
locating a first manageability data structure in the option ROM;
retrieving a first set of manageability data pertaining to the peripheral device from the first manageability data structure;
locating a second manageability data structure in the option ROM;
retrieving a second set of manageability data pertaining to the peripheral device from the second manageability data structure; and
employing the first and second set of manageability data to manage the peripheral device via the SEI subsystem.

24. The computer system of claim 21, wherein the computer system further includes a PCI (peripheral component interconnect) bus, operatively-coupled to the processor, to which a plurality of peripheral devices are coupled, and wherein execution of the plurality of instructions performs further operations including:
scanning the PCI bus for peripheral devices in the computer system;
for each device that is found,
determining if it has an option ROM; and if so,
determining if it includes a manageability data structure; and if so,
retrieving manageability data from the manageability data structure; otherwise,
proceeding to evaluate a next device; and
employing any manageability data that is retrieved to manage a corresponding device.
